(19) United States
(12) Patent Application Publication
(10) Pub. No.: US 2012/0219100 A1
(43) Pub. Date: Aug. 30, 2012

(54) IODINE-125 PRODUCTION SYSTEM AND METHOD

(75) Inventors: Manuel C. Lagunas-Solar, Davis, CA (US); Walter G. Steingass, Walnut Creek, CA (US); Hungyuan B. Liu, Roseville, CA (US)

(73) Assignee: THE REGENTS OF THE UNIVERSITY OF CALIFORNIA, Oakland, CA (US)

(21) Appl. No.: 13/466,696

(22) Filed: May 8, 2012

Related U.S. Application Data
(63) Continuation of application No. PCT/US2010/057677, filed on Nov. 22, 2010.
(60) Provisional application No. 61/263,786, filed on Nov. 23, 2009.

(51) Int. Cl. G21G 1/06

(52) U.S. Cl. 376/189

(57) ABSTRACT

Systems and methods using a double-walled portable container with pressurized gaseous Xe-124 are used as a target for thermal neutron irradiation that generates Xe-125. The portable container is transferred, while submerged in the reactor pool, to a mobile radiation shield container, which are then removed from the reactor pool and connected to the production apparatus that provides handling and recovery functions while properly shielded to minimize radiation exposure. A rapid and efficient transfer of induced Xe-125 and remaining Xe-124 is then accomplished into a clean spiral trap container in which the Xe-125 radioactivity is converted to Iodine-125. After the decay period is completed, Xe-124 and remaining Xe-125 are recovered leaving I-125 deposited on the internal surface of the spiral trap. I-125 is then removed with appropriate solvents.

### CROSS-REFERENCE TO RELATED APPLICATIONS

This application a 35 U.S.C. §111(a) continuation of PCT international application number PCT/US2010/057677 filed on Nov. 22, 2010, incorporated herein by reference in its entirety, which is a nonprovisional of U.S. provisional patent application Ser. No. 61/263,786 filed on Nov. 23, 2009, incorporated herein by reference in its entirety. Priority is claimed to each of the foregoing applications.

The above-referenced PCT international application was published as PCT International Publication No. WO 2011/063355 on May 26, 2011 and republished on Nov. 24, 2011, and is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to an iodine-125 production system, and more particularly to high-efficiency reactor-based production of iodine-125 with enriched, recyclable Xe-124 in single-use pressurized targets.

2. Description of Related Art

In one prior approach, Iodine-125 is produced by neutron irradiation of ¹²⁴Xe gas to form ¹²⁵Xe and permitting decay of ¹²⁵Xe to form ¹²⁵I. Irradiation of the xenon-124 is affected in a first chamber within an enclosure and decay is affected in a second chamber within the enclosure and free from neutron flux. The apparatus is submersible in a nuclear reactor pool so as to absorb any radiation escaping the apparatus during the process. Xenon can be caused to move between the chambers remotely, underwater. The second chamber is removable from said enclosure and is transported to a suitable location to recover the ¹²⁵I from its interior. Such recovery is affected by admitting an aqueous wash solution into the second chamber, whereupon it is heated. This causes water from the wash solution to reflux and cleanse the interior surfaces of the second chamber, thus creating an aqueous solution of ¹²⁵I, which then is caused to drain into a suitable container.

The above process, however, is complex, as it requires the majority of the processes in ¹²⁵I production to be performed under water in the reaction chamber. Maintenance of the system is accordingly difficult. In addition, if any failure of the target were to occur, it may be difficult or impossible to recover the ¹²⁴Xe gas, which may be costlier than the produced ¹²⁵I.

Accordingly, an object of the present invention is a system and method or providing a removable and portable target chamber that can be removed from the irradiation facility after irradiation, and can be safely accessed for additional processing during decay and ¹²⁵I production outside a reactor pool.

### BRIEF SUMMARY OF THE INVENTION

An aspect of the invention is a reactor-based system and method to produce Iodine-125 (60 d) for medical applications and research are described. The method is based on the use of the Xe-124 (n, gamma) Xe-125 (17.1 h)→I-125 nuclear reaction using enriched Xe-124 gas targets. The system is used to handle the induced radioactivity safely, rapidly and securely, including isolating and recovering the enriched Xe-124 gas for further use.

A key distinction of the present invention is the use of removable, self-contained target containers (that may be single-use), which may be removed from the reactor pool or tank once irradiation is completed, transferring valuable, enriched Xe-124 gas for recycling, storing induced radioactivity safely, and rapidly and securely and recovering the formed I-125 once an appropriate decay period is allowed.

A metallic container with pressurized gaseous Xe-124 is used as a target for thermal neutron irradiations. The induced, 17.1 h Xe-125 parent radioactivity results in a high radiation field and is transferred—while submerged in the reactor tank—to an appropriate mobile radiation shield container. The Pb shield and target are then rapidly removed from the reactor tank and connected to the production apparatus that provides all needed handling and recovery functions while properly shielded to minimize radiation exposure. A rapid and efficient transfer of induced Xe-125 (17.1 h) and remaining Xe-124 is then accomplished into a clean spiral trap container in which the Xe-125 radioactivity is converted to Iodine-125. After the decay period is completed, Xe-124 and remaining Xe-125 are recovered leaving I-125 deposited on the internal surface of the spiral trap. I-125 is then removed with appropriate solvents. All functions are controlled remotelly and/or automatically to provide a safe radiation environment.

This new method provides effective batch operation based upon removable pressurized gas targets to be handled outside the reactor tank, thus minimizing the potential for target failures associated with recycled targets, while greatly simplifying the handling of radioactive gases and the occurrence of radioactive leaks associated with more complex methods and apparatuses. Because of this simplification, higher I-125 production yields are obtained as surface losses of I-125 are greatly minimized while operating with higher recovery efficiencies.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of the target vessel of the present invention in a central irradiation facility in accordance with the present invention.

FIG. 2 is a schematic diagram of an expanded view of the upper portion of the target vessel of FIG. 1.

FIG. 3 is a schematic diagram of a system for Xe-125 transfer, decay and reloading in accordance with the present invention.

FIG. 4 is a schematic diagram of an I-125 recovery and fractionation system in accordance with the present invention.

FIG. 5 illustrates a target vessel with shield assembly in accordance with the present invention.

FIG. 6 is flow diagram of a method for producing Iodine-125 (60 d) from irradiating Xe-124 in accordance with the present invention.

### DETAILED DESCRIPTION OF THE INVENTION

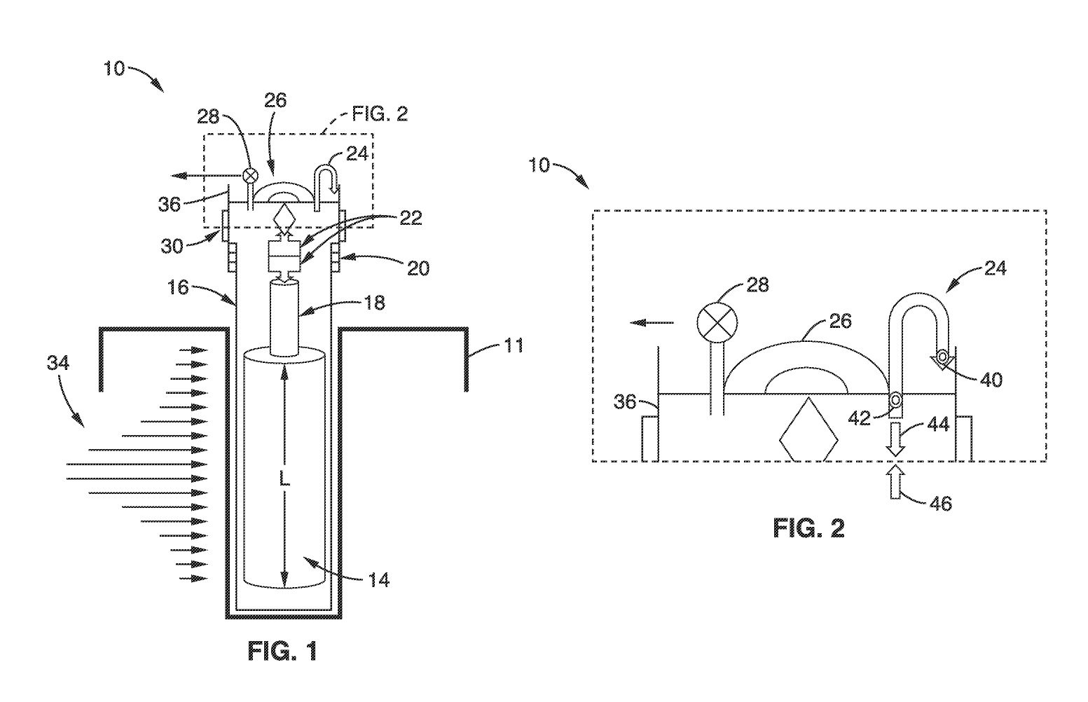

Referring more specifically to the drawings, for illustrative purposes the present invention is intended to an improved batch production system and process as illustrated in FIG. 1 through FIG. 6. It will be appreciated that the systems may vary as to configuration and as to details of the parts, and that the method may vary as to the specific steps and sequence, without departing from the basic concepts as disclosed herein.

As an initial introduction, various respective aspects, modes, embodiments, variations, and features of the invention are herein shown and described, both broadly and in variously increasing levels of detail. Each provides individual benefit, either in its own regard, or in the ability to provide enhanced modes of operation by way of combinations with other aspects or features. Moreover, their various combinations, either as specifically shown or apparent to one of ordinary skill, may provide further benefits in production of I-125.

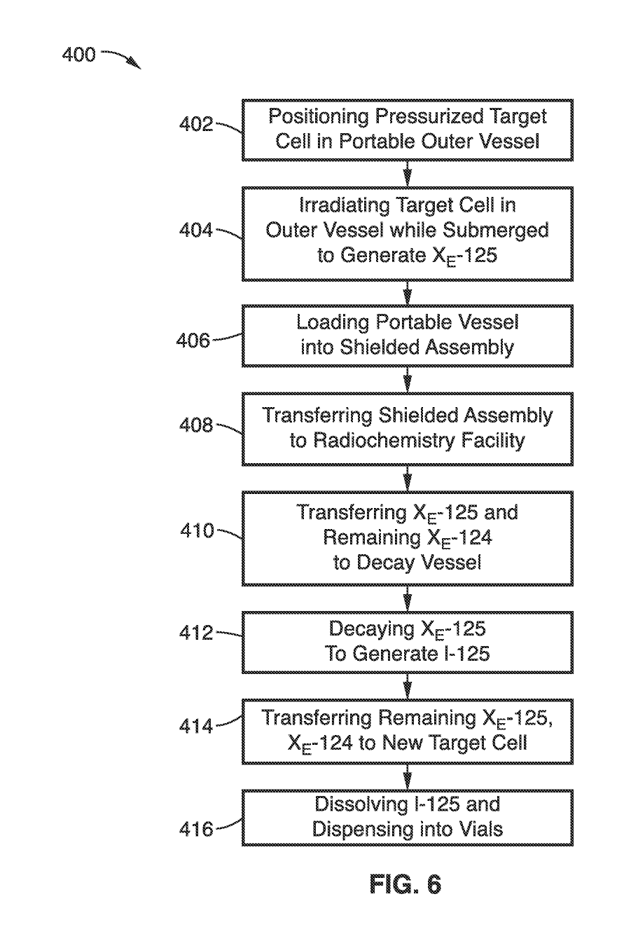

FIG. 1 through FIG. 5 illustrate systems 10, 100, 200 for carrying out a batch process 400 for the large-scale production of I-125 (60.1 d) via the ¹²⁴Xe(n,γ)¹²⁵Xe (17.1 h)→¹²⁵I reaction, as shown in FIG. 6.

FIG. 1 shows schematic diagram of a removable target vessel assembly 10 of the present invention in a central irradiation facility (CIF) 11. The central irradiation facility (CIF) 11 generally comprises an open-ended graphite enclosure that is configured to be immersed in water during irradiation. Target vessel assembly 10 comprises a target vessel 14 having length L loaded with enriched Xe-124 (preferably >99%) that is double-contained within target vessel 14 and a secondary outer vessel 16.

The target vessel 14 generally comprises a stainless steel (or other suitable vessel) that is pressurized, preferably to approximately 200 psi (although other pressured may be used). The target vessel 14 is configured to be bombarded with thermal neutron flux distribution 34 to irradiate the Xe-124 for a period of between 1 and 40 hours, and preferably about 20 hours to generate a Xe-125/Xe-124 gas mixture.

The target vessel 14 is retained to hang within in the outer vessel 16 via connection 50 and heavy wall tube extension 18. Enriched Xe-124 may be loaded into target vessel 14 while in target vessel assembly 10 via automatic sealed mechanical bellow valves 22 that retain the gas from inadvertent leakage. While only one valve 22 may be sufficient, it is preferred to have two valves as detailed in FIG. 1, to provide redundant protection in case of failure of a first valve.

The cover assembly 36 is configured to be attached to the outer vessel 16 via a threaded seal 20. However, other attachment means, e.g. welding or the like, may be used secure the cover assembly 36 to the outer vessel 16. The cover assembly 36 may also comprise ears 30 for remote opening. The top of the cover assembly 36 may include a handling hook 26 for transporting the target assembly 10.

FIG. 2 illustrates expanded view of the upper portion of the target vessel assembly 10. The cover assembly 36 comprises a valve 28 providing access to the outer vessel to establish a desired pressure (e.g. vacuum for atmosphere). The cover assembly 36 may comprise a pressure sensor 24 as available in the art. In a preferred embodiment, the pressure sensor 24 may comprise a tube with ball indicator. When the outer vessel 16 is pumped down to a vacuum pressure (indicated as arrow 44) the ball indicator is shown at location 42 at the lower position within the tube. If a leak of the pressurized target container 14 occurs, the pressure inside the outer vessel will increase, which is reflected at the upper position 40 in indicator 24.

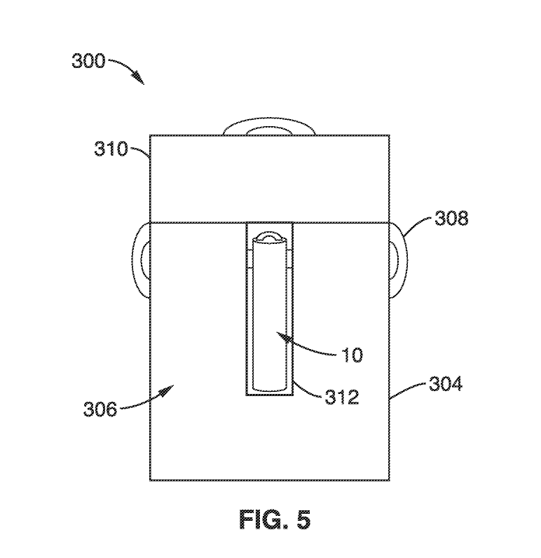

At the end of bombardment (EOB), the target 10 will be removed from CIF 11 using appropriate handling tools and transferred into a submerged, pre-positioned lead (Pb) shield assembly 300 shown in FIG. 5. The Pb shield assembly 300 comprises a cavity 312 surrounded by Pb walls 306 in all directions, including lid 310, all disposed within SS layer 304. The Pb shield 300 is preferably configured to provide a ˜4.8×10⁻⁷ attenuation factor (using a HVL=0.93 cm; or μ=0.744 cm) of the radiation field from the Xe-125 radioactivity. As an example, with 2,000 Ci of Xe-124, a radiation field of 2.6×10⁶ mr/h at 30 cm is estimated in air. Inside the Pb shield, however, the radiation field would be reduced to 1.2 mr/h at 30 cm. Therefore, the Pb shield 300 is configured for a ¹²⁵Xe-holding capacity several times (˜8 times) higher and still remain at <10 mr/h at 30 cm. This latter level is assumed safe for short-duration exposures.

Still in the reactor tank (not shown—using water as a shield), after the target assembly 10 is loaded into the Pb shield 300, the Pb lid 310 is applied to provide 4π shielding. A crane, or other device, is then used to lift and position (e.g. via handles 308) the capped Pb shield assembly 300 containing the target assembly 10 into the reactor room floor. Because of water contaminants are present and therefore the Pb shield 300 is expected to be wet and surface contaminated, proper radiation safety practices may be implemented to secure the area and to prevent dispersion of contaminants.

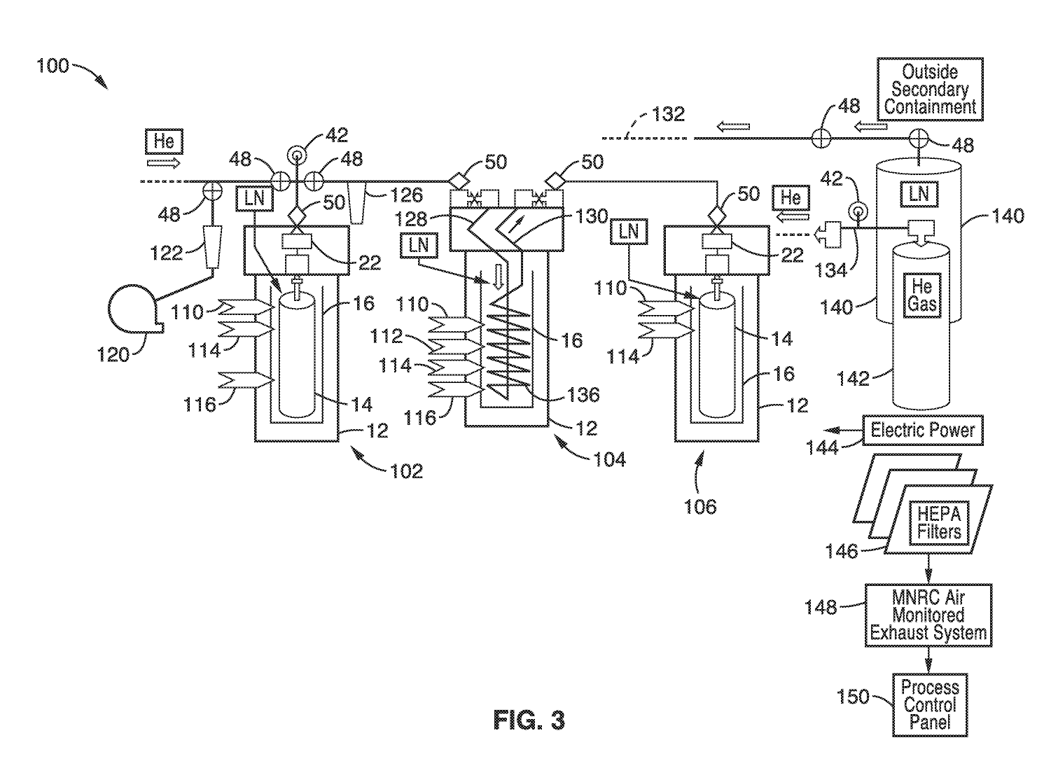

Referring now to FIG. 3, the Pb shield 300 and target 10 are then transported (shown as combined assembly 102) to Xe-125 transfer, decay and target reloading system 100. The target 10 may be retained in the Pb shielding 102, or be positioned in a Pb shield 12 already in place. During positioning of target loaded Pb shield assembly 102, remote viewing of the pressure indicator 42 (24) of the target Al secondary containment vessel 16 is inspected to assure primary target 14 integrity. If the pressure indicator 24 reveals higher pressure than initial conditions, a primary target leak (rupture) should be suspected and the production run terminated. Emergency procedures may be initiated.

The Xe-125 transfer, decay and target reloading system 100 allows for the rapid, efficient cryogenic transfer of Xe-125 and remaining Xe-124 (the target gas) from target vessel 14 to a SS decay vessel 104 while leaving behind I-126 radioactivity formed by ¹²⁵I(n,γ)¹²⁶I(13.0 d) reaction (σ_{γ}=900 b) during bombardment.

Helium is used to drive the Xe-125/Xe-124 gas mixture (via pump 120 and filter 122) from the target container 14 to the decay vessel 104.

FDA regulations for clinical-grade Xe-125 specify that <1 ppm of I-126 be present at time of calibration (TOC). Thus filter 126 is disposed between the irradiated ¹²⁴Xe gas target and the decay vessel 104 to trap I-126 from the input 128 into the decay vessel 104.

After the Xe-125/Xe-124 gas mixture is transferred to the decay vessel 104 and the system is secured, 3-5 days are allowed for the stored Xe-125 to decay to I-125. Decay vessel 104 comprises a clean, crogenically cooled, spiral trap 136 in which the Xe-125 radioactivity is converted to Iodine-125. After the decay period is completed, Xe-124 and remaining Xe-125 are retrieved out line 130, leaving I-125 deposited on the internal surface of the spiral trap 136.

After the decay period is completed, the remaining Xe-125 and the Xe-124 gas target are transferred cryogenically to a pre-positioned new SS target vessel 106. The new SS target vessel 106 will contain ˜200 psi Xe-124 and the remaining Xe-125 and will be ready for a new irradiation cycle. However, it should be noted that the new target will also contain I-125 from the decay of the parent Xe-125 and thus the formation of I-125 is enhanced.

Electronic valves 48 are positioned at each of the vessels 102, 104 and 106, and preferrably two at each port (e.g. input 138 and output 130 of decay vessel 104) for redundancy. As shown in FIGS. 1-4, electronic valves 48 are primarily used external to the containers, and mechanical valves 22 are used primarily external to the containers. However, it is appreciated that electronic valves and mechanical valves may be used interchangeably within the systems 10, 100, and 200.

Liquid nitrogen (LN) is also introduced into each vessel 102, 104 and 106 to promote efficiency in decay of I-125 and trapping I-126. Various sensors for process control may also be provided at each of the components 102, 104, and 106 (i.e. radiation sensor 114, temperature sensor 112, LN level sensor 110, etc.). Dry heaters 116 may also be provided for heating the irradiated target 102 and decay vessel 104.

Outside secondary containment are LN and He gas tanks 140, 142 for supplying He and LN to the system. The process is controlled via process control panel 150 which controls function and power 144 to the individual components. HEPA filters 146 may also be provided to catch any contaminants/radiation that may be expelled from the system 100, and monitored via radiation sensor 114 exhaust system 148.

Xe-125 transfer, decay and target reloading system 100 is generally configured to provide the following features: (a) full containment; (b) adequate radiation shielding; (c) air exhaust monitoring 148; (d) easy positioning of heavy, target loaded Pb shield 300; (e) automatic/remote opening of target secondary container vessel; (e) connection of target vessel 13 to operating system; (f) various sensors for process control (i.e. radiation, temperature, LN level, pressure, etc.); (g) connections to ancillary services and materials (LN, He gas, etc.); and (h) a process control panel 150.

The entire system 100 may be housed in a SS radioisotope hood (not shown) with easy access and inert surfaces for repairs, maintenance and other required practices. The system 100 is capable of withstanding an estimated 3-4 tons including the Pb shield 300 and additional localized Pb shielding.

Once the decay period (approximately three to five days) is completed, the decay vessel 104 containing I-125 and traces of Xe-125 will be removed and transferred to another facility for further processing, quality controls and distribution of Xe-125 to the user community.

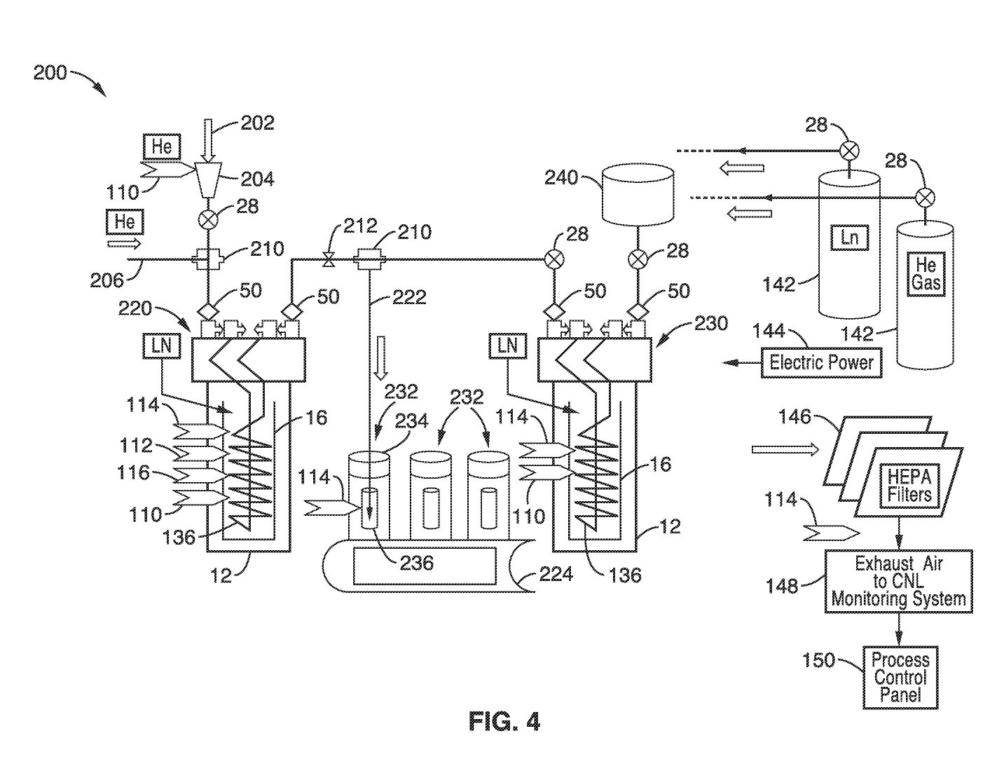

Referring now to FIG. 4, I-125 Recovery & Fractionation System 200 allows for washing the I-125 radioactivity remotely by using a sterile, pyrogen-free sodium hydroxide solution 110 (0.1 N NaOH) into pre-labeled, Pb shielded, pharmaceutical-quality glass vials 236 with an appropriate level of I-125. These vials 236, or portions of them, will be the source of certified I-125 to be distributed to the user community.

Once the decay vessel (shown as vessel 22 in FIG. 4) has been secured into the system 200 and the system tested for integrity (pressure sensors and/or He detector), a controlled, metered He flow 202 will be used in conjunction with heated N NaOH input 204 to remove any traces of Xe-125 remaining in the decay vessel 220. Any Xe-125 would be trapped into a cryogenically (LN cooled) heavy-wall Cu spiral decay/storage vessel 230. The formation of I-125 in the vessel from the decay of its Xe-125 parent results into a strong binding with Cu due to the recoil energy of the highly-ionized newly-born I-125 atom. Non-decayed Xe-125 is trapped cryogenically in the large size Cu spiral trap 230 as well. The out-flow He stream from the Cu spiral trap 230 will be thru a large size airborne I-125 filter 240 to prevent any uncontrolled releases. Once this preparatory phase is completed, the system is ready for dissolving the I-125 and for dispensing it into one or several product vials 236.

Flow indicators 212, three-way valves 210, on/off valves 28 and connectors 50 are positioned at various locations within the system 200 for control of process flow. The Xe-125 fill line 222 is directed to automatic dispensing unit 234 (which may comprise an automated assembly belt of the like) for filling files within containers 232, each comprising filters 234 to screen for any surface aerosols/contaminants from the process.

All motions and process controls for the operation described above are to be automatic or remotely controlled. Outside secondary containment are LN and He gas tanks 140, 142 for supplying He and LN to the system. The process is controlled via process control panel 150 which controls function and power 144 to the individual components. HEPA filters 146 may also be provided to catch any contaminants/radiation that may be expelled from the system 100, and monitored via radiation sensor 114 exhaust system 148.

The Xe-125 recovery & fractionation system 200 in FIG. 4 is configured to provide the following features: (a) full containment; (b) adequate radiation shielding; (c) air exhaust monitoring; (d) easy positioning of Pb shielded Decay Vessel; (e) automatic/remote operation; (e) various sensors 112, 114, and 116 for process control (i.e. radiation, temperature, LN level, pressure, etc.); (g) connections to ancillary services and materials (dry heating, LN, He gas, etc.); and (h) a process control panel.

The entire system 200 may be housed in a SS radioisotope hood (not shown) with easy access and inert surfaces for cleaning, repairs, maintenance and other required practices including installation of new production devices. The system should be capable of withstanding an estimated 1-2 tons including Pb shield and additional shielding Pb-glasses providing viewing ports. Visual observation of the process may also utilize digital camera set ups with remote displays (not shown).

Small aliquots (10's of μL) may be obtained from the product vials 236 and be subjected to the various quality control tests, when applicable and required: (a) product identity (Gamma-ray spectrometry); (b) product concentration [mCi/mL to Ci/mL] (gamma-ray spectrometry of known volume; dose calibrators); (c) radiochemical analysis (radio chromatography); (d) chemical analysis (X-Ray Fluorescence Analysis [XRF); Neutron activation [NAA]); (e) specific activity (XRF and/or NAA); (f) biological controls (sterility and pyrogenicity). A QC Laboratory (not shown) may be situated nearby to provide regular access to all the above tests and be in compliance with all applicable radiopharmacy regulations.

Once the I-125 product is certified as in compliance, the I-125 batch may be fractionated (divided) into appropriate sterile, labeled, pyrogen-free containers, or in another suitable form. Packaging of properly labeled product vials will follow applicable DOT regulations. Distribution of packaged I-125 shall follow appropriately sanctioned users (buyers) who must demonstrate appropriate records of issued licenses to posses the type and amount of I-125 being shipped.

All procedures listed in this document are to conform to all Federal, State and University regulations to allow processing and certification of I-125 and have documented training and experience in accordance with all applicable regulations.

FIG. 6 illustrates a flow diagram of a method 400 for producing Iodine-125 (60 d) from irradiating Xe-124 in accordance with system of the present invention described in FIGS. 1-5 above. At block 402, the pressurized target cell 14 is positioned within the portable outer vessel 402. At block 404, the assembly 10 is positioned within the CIF 11 (under water) and irradiated to generate Xe-125. At block 406, the assembly 10 is loaded into a Pb shielding assembly (while under water). At block 408, the Pb shielded assembly 102 is transferred out of the water to the radiochemistry facility 100. At block 410, the irradiated Xe-125 and remaining Xe-124 are transferred from the target cell 14 to a decay vessel 104. At block 412, Xe-125 is decayed to generate I-125. At block 141, the remaining Xe-125, and Xe-124 are transferred to a new target cell 106. At step 416, the generated I-125 is dispensed into vials 236.

Potential benefits of the system and methods of the present invention include:

(1) Single-use targets provide higher overall production reliability while minimizing risks associated with reusable systems;

(2) Operating system is greatly simplified and readily accessible for maintenance and repair;

(3) Risks for loss of containment with continuous loop systems or complex submerged systems are minimized;

(4) Higher yields are possible;

(5) Multiple target irradiations are possible to maximize I-125 production yields by using other reactor tank positions for irradiation.

From the description herein it will be appreciated that the present invention can be embodied in various ways, including but not limited to the following:

1. A method for generating I-125, comprising: irradiating, with neutron radiation, a target container while submerged in a reactor pool; the target container comprising a double-walled vessel configured for holding an amount of Xe-124 gas; forming Xe-125 from the irradiated Xe-124 gas; removing the target container from the reactor pool; removing, from the target container, an amount of the radiation induced Xe-125 and amount of remaining Xe-124 gas and transferring the Xe-125 and Xe-124 to a trap container; allowing an amount of the Xe-125 in the trap container decay into I-125 for a period of time; removing, from the trap container, an amount of remaining Xe-124 and an amount of remaining Xe-125; and recovering, from the trap container, an amount of I-125.

2. A method as recited in claim 1, wherein the target container is a single-use container.

3. A method as recited in embodiment 1: wherein the target container comprises a pressurized inner container and a outer secondary container that is sealed to be substantially at or below atmospheric pressure; wherein the outer secondary container comprises a pressure sensor such that an increase in pressure in the outer secondary container indicates a leak in the pressurized inner container.

4. A method as recited in embodiment 3: wherein the target container is transferred to a mobile radiation shield container after irradiation and while submerged in the reactor pool; wherein the mobile radiation shield container and target container are subsequently removed from the reactor pool and connected to an apparatus for recovering I-125.

5. A method as recited in embodiment 3: wherein the trap container comprises a spiral trap container; and wherein the trap container has an internal surface upon which I-125 is deposited.

6. A method as recited in embodiment 5, wherein the Xe-125 and Xe-124 from the target container is filtered to remove Xe-126 prior to being delivered into the spiral trap container.

7. A method as recited in embodiment 4, wherein the mobile radiation shield container comprises a submerged, pre-positioned Pb shield in the reactor pool.

8. A method as recited in embodiment 7, wherein after the target container is loaded into the Pb shield, a Pb lid is applied to provide additional shielding.

9. A method as recited in embodiment 1, wherein after the decay period is completed, the remaining Xe-125 and Xe-124 gas target are transferred cryogenically to a pre-positioned second target vessel.

10. A method as recited in embodiment 9, wherein the second target vessel is configured to be loaded with the remaining Xe-124 and Xe-125 at approximately 200 psi for reintroduction into a new irradiation cycle.

11. A method as recited in embodiment 5, wherein the I-125 is recovered from the trap container by flushing the trap container with a heated sodium hydroxide solution.

12. A method as recited in embodiment 11, wherein the recovered I-125 is dispensed into individual vials; wherein said dispensing of I-125 is performed automatically and is controlled from a remote location.

13. A system for generating I-125, comprising: a target container comprising a double-walled vessel configured for holding an amount of Xe-124 gas; said target container configured to be submerged within a reactor pool and irradiated with neutron radiation to form Xe-125 from the irradiated Xe-124 gas; and a trap container; said target container configured to be removed, subsequent to irradiation and coupled to the trap container at a location outside said pool; said target container comprising at least one valve for transferring an amount of the radiation induced Xe-125 and amount of remaining Xe-124 gas from the target container; the trap container configured to hold of the Xe-125 in the trap container for a period of time to decay into I-125.

14. A system as recited in embodiment 13, wherein the target container is a single-use container.

15. A system as recited in embodiment 13: wherein the target container comprises a pressurized inner container and a outer secondary container that is sealed to be substantially at or below atmospheric pressure; wherein the outer secondary container comprises a pressure sensor such that an increase in pressure in the outer secondary container indicates a leak in the pressurized inner container.

16. A system as recited in embodiment 15, further comprising: mobile radiation shield container; wherein the target container configured to be transferred to a mobile radiation shield container after irradiation and while submerged in the reactor pool; wherein the mobile radiation shield container and target container are configured to be removed from the reactor pool and connected to the trap container.

17. A system as recited in embodiment 15: wherein the trap container comprises a cryogenically cooled container comprising a spiral feed line; and wherein a spiral feed line has an internal surface upon which I-125 is deposited.

18. A system as recited in embodiment 17, further comprising: a filter disposed between the target container and the trap container; wherein the filter is configured to remove Xe-126 from the Xe-125 and Xe-124 prior to being delivered into the trap container.

19. A system as recited in embodiment 16, wherein the mobile radiation shield container comprises a Pb shield configured to be submerged and pre-positioned in the reactor pool.

20. A system as recited in embodiment 19, wherein the mobile radiation shield container comprises cavity in which the target container may be loaded, and a Pb lid to provide additional shielding over said cavity.

21. A system as recited in embodiment 15, further comprising: a second target vessel; the second target vessel configured to be coupled to the trap container; wherein after the decay period is completed, the remaining Xe-125 and the Xe-124 gas target are transferred cryogenically to the second target vessel.

22. A system as recited in embodiment 21, wherein the second target vessel is configured to be loaded with the remaining Xe-124 and Xe-125 at approximately 200 psi for reintroduction into a new irradiation cycle.

23. A system as recited in embodiment 15, further comprising a He supply coupled to the trap container; the He supply line configured to flush the trap container with a heated sodium hydroxide solution to recover I-125 from the trap container.

24. A system as recited in embodiment 23, further comprising: an automatic dispensing assembly; wherein the automatic dispensing assembly is configured to dispense the recovered I-125 into individual vials; wherein the automatic dispensing assembly is configured to be controlled from a remote location.

25. An apparatus for generating I-125, comprising: a target container comprising a double-walled vessel configured for holding an amount of Xe-124 gas; said target container configured to be submerged within a reactor pool and irradiated with neutron radiation to form Xe-125 from the irradiated Xe-124 gas; wherein the target container comprises a pressurized inner container and a outer secondary container that is sealed to be substantially at or below atmospheric pressure; wherein the outer secondary container comprises a pressure sensor such that an increase in pressure in the outer secondary container indicates a leak in the pressurized inner container; said target container configured to be removed subsequent to irradiation and coupled to the a trap container at a location outside said pool; said target container comprising at least one valve for transferring an amount of the radiation induced Xe-125 and amount of remaining Xe-124 gas from the target container.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for generating I-125, comprising:
irradiating, with neutron radiation, a target container while submerged in a reactor pool;
the target container comprising a double-walled vessel configured for holding an amount of Xe-124 gas;
forming Xe-125 from the irradiated Xe-124 gas;
removing the target container from the reactor pool;
removing, from the target container, an amount of the radiation induced Xe-125 and amount of remaining Xe-124 gas and transferring the Xe-125 and Xe-124 to a trap container;
allowing an amount of the Xe-125 in the trap container decay into I-125 for a period of time;
removing, from the trap container, an amount of remaining Xe-124 and an amount of remaining Xe-125; and
recovering, from the trap container, an amount of I-125.

2. A method as recited in claim 1, wherein the target container is a single-use container.

3. A method as recited in claim 1:
wherein the target container comprises a pressurized inner container and a outer secondary container that is sealed to be substantially at or below atmospheric pressure;
wherein the outer secondary container comprises a pressure sensor such that an increase in pressure in the outer secondary container indicates a leak in the pressurized inner container.

4. A method as recited in claim 3:
wherein the target container is transferred to a mobile radiation shield container after irradiation and while submerged in the reactor pool;
wherein the mobile radiation shield container and target container are subsequently removed from the reactor pool and connected to an apparatus for recovering I-125.

5. A method as recited in claim 3:
wherein the trap container comprises a spiral trap container; and
wherein the trap container has an internal surface upon which I-125 is deposited.

6. A method as recited in claim 5, wherein the Xe-125 and Xe-124 from the target container is filtered to remove Xe-126 prior to being delivered into the spiral trap container.

7. A method as recited in claim 4, wherein the mobile radiation shield container comprises a submerged, pre-positioned Pb shield in the reactor pool.

8. A method as recited in claim 7, wherein after the target container is loaded into the Pb shield, a Pb lid is applied to provide additional shielding.

9. A method as recited in claim 1, wherein after the decay period is completed, the remaining Xe-125 and Xe-124 gas target are transferred cryogenically to a pre-positioned second target vessel.

10. A method as recited in claim 9, wherein the second target vessel is configured to be loaded with the remaining Xe-124 and Xe-125 at approximately 200 psi for reintroduction into a new irradiation cycle.

11. A method as recited in claim 5, wherein the I-125 is recovered from the trap container by flushing the trap container with a heated sodium hydroxide solution.

12. A method as recited in claim 11, wherein the recovered I-125 is dispensed into individual vials;
wherein said dispensing of I-125 is performed automatically and is controlled from a remote location.

13. A system for generating I-125, comprising:
a target container comprising a double-walled vessel configured for holding an amount of Xe-124 gas;
said target container configured to be submerged within a reactor pool and irradiated with neutron radiation to form Xe-125 from the irradiated Xe-124 gas; and
a trap container;
said target container configured to be removed, subsequent to irradiation and coupled to the trap container at a location outside said pool;
said target container comprising at least one valve for transferring an amount of the radiation induced Xe-125 and amount of remaining Xe-124 gas from the target container;
the trap container configured to hold of the Xe-125 in the trap container for a period of time to decay into I-125.

14. A system as recited in claim 13, wherein the target container is a single-use container.

15. A system as recited in claim 13:
wherein the target container comprises a pressurized inner container and a outer secondary container that is sealed to be substantially at or below atmospheric pressure;
wherein the outer secondary container comprises a pressure sensor such that an increase in pressure in the outer secondary container indicates a leak in the pressurized inner container.

16. A system as recited in claim 15, further comprising:
mobile radiation shield container;
wherein the target container configured to be transferred to a mobile radiation shield container after irradiation and while submerged in the reactor pool;
wherein the mobile radiation shield container and target container are configured to be removed from the reactor pool and connected to the trap container.

17. A system as recited in claim 15:
wherein the trap container comprises a cryogenically cooled container comprising a spiral feed line; and
wherein a spiral feed line has an internal surface upon which I-125 is deposited.

18. A system as recited in claim 17, further comprising:
a filter disposed between the target container and the trap container;
wherein the filter is configured to remove Xe-126 from the Xe-125 and Xe-124 prior to being delivered into the trap container.

19. A system as recited in claim 16, wherein the mobile radiation shield container comprises a Pb shield configured to be submerged and pre-positioned in the reactor pool.

20. A system as recited in claim 19, wherein the mobile radiation shield container comprises cavity in which the target container may be loaded, and a Pb lid to provide additional shielding over said cavity.

21. A system as recited in claim 15, further comprising:
a second target vessel;
the second target vessel configured to be coupled to the trap container;
wherein after the decay period is completed, the remaining Xe-125 and the Xe-124 gas target are transferred cryogenically to the second target vessel.

22. A system as recited in claim 21, wherein the second target vessel is configured to be loaded with the remaining Xe-124 and Xe-125 at approximately 200 psi for reintroduction into a new irradiation cycle.

23. A system as recited in claim 15, further comprising a He supply coupled to the trap container;
the He supply line configured to flush the trap container with a heated sodium hydroxide solution to recover I-125 from the trap container.

24. A system as recited in claim 23, further comprising:
an automatic dispensing assembly;
wherein the automatic dispensing assembly is configured to dispense the recovered I-125 into individual vials;
wherein the automatic dispensing assembly is configured to be controlled from a remote location.

25. An apparatus for generating I-125, comprising:
a target container comprising a double-walled vessel configured for holding an amount of Xe-124 gas;
said target container configured to be submerged within a reactor pool and irradiated with neutron radiation to form Xe-125 from the irradiated Xe-124 gas;
wherein the target container comprises a pressurized inner container and a outer secondary container that is sealed to be substantially at or below atmospheric pressure;
wherein the outer secondary container comprises a pressure sensor such that an increase in pressure in the outer secondary container indicates a leak in the pressurized inner container;
said target container configured to be removed subsequent to irradiation and coupled to the a trap container at a location outside said pool; and
said target container comprising at least one valve for transferring an amount of the radiation induced Xe-125 and amount of remaining Xe-124 gas from the target container.
